(19) United States
(12) Patent Application Publication
(10) Pub. No.: US 2008/0040737 A1
(43) Pub. Date: Feb. 14, 2008

(54) Reading/Writing Optical Device Having Temperature Compensation

(75) Inventors: Petrus Theodorus Jutte, Eindhoven (NL); Peter Coops, Eindhoven (NL)

Correspondence Address: BAINWOOD HUANG & ASSOCIATES LLC, 2 CONNECTOR ROAD, WESTBOROUGH, MA, 01581, US

(73) Assignee: Arima Devices Corporation TrustNet Chambers, Road Town (VG)

(21) Appl. No.: 10/574,367

(22) PCT Filed: Oct. 7, 2004
(86) PCT No.: PCT/IB04/52013

§ 371 Date: Apr. 16, 2007

(30) Foreign Application Priority Data
Oct. 15, 2003 (EP) 03103812.8

(51) Int. Cl. G11B 7/08

(52) U.S. Cl. 720/681

(57) ABSTRACT

An optical data reading/writing device for reading/writing to an information layer, the device comprising at least a first radiation source (12) for generating a radiation beam and an optical system (10, 40, 44, 46, 48, 50, 52, 54, 56) for converging the radiation beam on the information layer and for converging the radiation beam reflected by the information layer onto a detector, wherein the optical system incorporates a wavelength sensitive structure which compensates for a temperature-induced defocusing of the optical system.

This invention relates to an optical reading/writing device having temperature compensation and a method of compensating for temperature induced defocusing in an optical reading/writing device.

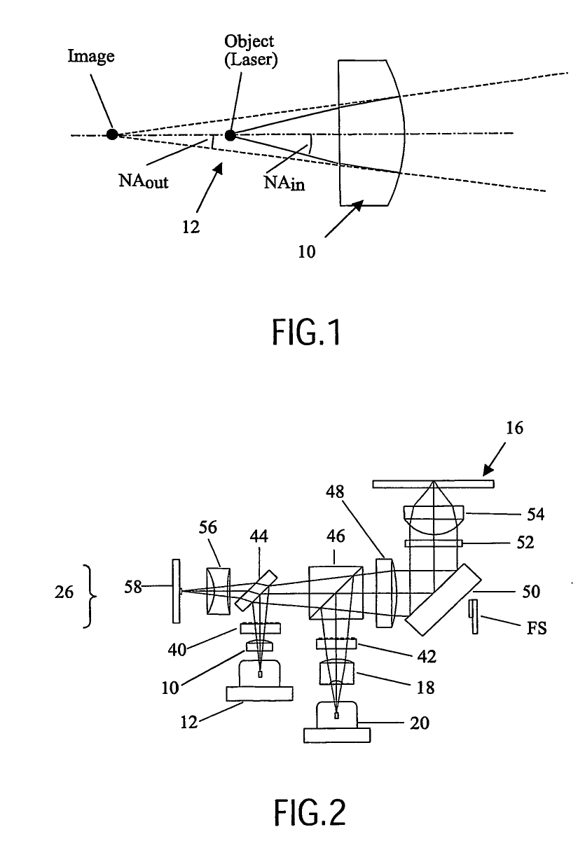

In FIG. 1 a side view of a pre-collimator 10 is shown with a laser 12 and the relevant light paths. In FIG. 2, a prior art optical layout for a CD/DVD double writer is shown. In such known optical systems a pre-collimator 10 is a lens positioned in front of a laser 12, to reduce the beam divergence of the laser beam. See FIG. 1.

A typical property of a pre-collimator 10 is:

$$\frac{{NA}_{out}}{{NA}_{in}} < 1$$

where NAₒᵤₜ is the numerical aperture of the beam after passage through the pre-collimator 10 and NAᵢₙ is the numerical aperture of the beam before a passage through the pre-collimator 10.

For a Combi (DVD read and CDR(W) recording) or a double writer (DVD±R(W) and CDR(W) recording) with one objective lens 24 a pre-collimator 10 for the CD branch 14 is necessary in order to get enough power on a disk 16 for CD (coupling efficiency) and sufficient rim intensity (ie intensity at the rim of the laserbeam effectively used) for DVD read out, as shown in FIG. 2.

For DVD±RW recorder applications a beam-shaper 18 is often applied to compensate for the different beam divergence from a semiconductor laser 20 parallel and perpendicular to the active layer. One option is using a lens type of beam-shaper 18 (see FIG. 2).

The double writer also comprises a CD path grating 40, DVD path grating 42, plate-type beam-splitter 44, cube-type beam-splitter 46, collimator 48, folding mirror 50, λ/4 plate 52, objection lens 54, servo lens 56 and photodiode 58.

The DVD path may be termed a high density (HD) path for a disc having a HD information layer. The CD path may be termed a low density (LD) path for a disc having a LD information layer.

For cost reasons a plastic pre-collimator 10 or beam-shaper 18 is very attractive. However, a major problem of such a plastic optical component is defocusing in the disk 16 due to shift of the focal length of that optical component with temperature, because the plastic pre-collimator 10 or beam-shaper 18 is only in the CD laser branch 14 or DVD laser branch 22 and not in a detector branch 24. An expression of the defocusing in the disk is (approximation with planar convex lens):

$$\frac{d z}{d T} = \frac{{( 1 - \frac{{NA}_{in}}{{NA}_{out}} )}^{2} \cdot f}{( 2 \cdot {m}_{c}^{2} ) \cdot ( n - 1 )} \cdot \frac{d n}{d T} \qquad ( 1 )$$

in which, the focal length of the pre-collimator 10 is f; n is the refractive index of the pre-collimator 10; m. is the magnification from collimator to objective lens. With some practical values for dn/dT=−12.10⁻⁵, n=1.57 and ΔT=40° C. the defocus is 0.8 μm on the disk 16 for f=12 mm and NAᵢₙ/NAₒᵤₜ=1.8 and m_{c}=5.

One option to limit the defocus is the application of a short focal length as described in WO 02/31823 (=PHNL000552), the contents of which are incorporated herein by reference.

A property of semiconductor lasers is that the wavelength λ is dependent on the temperature T. See Table 1.

TABLE 1
Typical data of the wavelength change with
temperature of a semiconductor laser.

| Wavelength | dλ/dT typical |
|---|---|
| λ~660 nm | 0.20 nm/° C. |
| λ~780 nm | 0.25 nm/° C. |
| λ~405 nm | 0.07 nm/° C. |

It is an object of the present invention to limit the effect of temperature sensitivity of optical components on defocus in optical systems.

According to a first aspect of the invention an optical data reading/writing device for reading/writing to an information layer, the device comprising at least a first radiation source for generating a radiation beam and an optical system for converging the radiation beam on the information layer and for converging the beam reflected by the information layer onto a detector, wherein the optical system incorporates a wavelength sensitive structure which compensates for a temperature-induced defocusing of the optical system.

The wavelength sensitive structure may be a part of a refracting pre-collimator, a beam-shaper or a sensor lens of the optical system.

The addition of a wavelength sensitive structure to the optical system advantageously allows for temperature compensation in the optical system, especially in a pre-collimator/beam-shaper/sensor lens made of plastics material.

The wavelength sensitive structure is preferably located out of a common path of the radiation beam produced by the at least first radiation source, where the common path is a path used for both converging the radiation beam on the information layer and converging the beam reflected by the information layer onto the detector. The common path can be different for different radiation beams. The wavelength sensitive structure is preferably located between the at least first radiation source and a pre-collimator/beam-shaper or may be located between a beam-splitter element and a detector element of the optical data reading/writing device.

Preferably, the wavelength sensitive structure is a grating structure.

The wavelength sensitive structure may be a stepped phase structure.

The wavelength sensitive structure may be a non-periodic phase structure. The wavelength sensitive structure may be a diffractive structure, such as a blazed grating or kinoform grating.

Advantageously, the wavelength sensitive structures used are wavelength sensitive, thus allowing the temperature compensation desired.

The reading/writing device may incorporate at least first and second radiation sources for reading/writing to different types or formats of information layer.

The first radiation source may be suitable for a first format of information layer, such as a CD format. In which case the wavelength sensitive structure may be part of a pre-collimator. The wavelength sensitive structure preferably faces the first radiation source.

The second radiation source may be suitable for a second format of information layer, such as a DVD format. In which case the wavelength sensitive structure may be part of a beam-shaper. The wavelength sensitive structure preferably faces the second radiation source.

According to a second aspect of the present invention a method of compensating for temperature-induced defocusing of an optical system in an optical reading/writing device comprises including a wavelength sensitive structure in the optical system, which wavelength sensitive structure compensates for said defocusing.

The method may include the wavelength sensitive structure facing a radiation source of the reading/writing device.

The method may include compensating for defocusing in at least two elements of the optical system in which case each element may have an associated wavelength sensitive structure.

According to a third aspect of the invention, a refracting pre-collimator/beam-shaper/sensor lens for compensating for temperature defocusing incorporates a wavelength sensitive structure adapted to compensate for temperature defocusing.

All of the features described herein may be combined with any of the above aspects, in any combination.

For a better understanding of the invention, and to show how embodiments of the same may be carried into effect, reference will now be made, by way of example, to the accompanying diagrammatic drawings in which:

FIG. 1 is a schematic side view of a pre-collimator;

FIG. 2 is a schematic diagram of a prior art double optical writer;

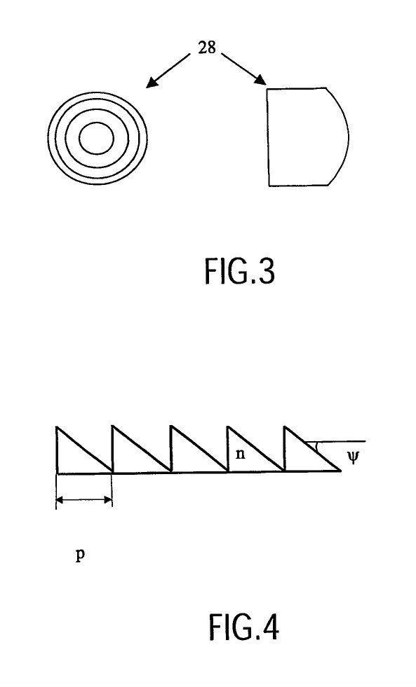

FIG. 3 is a schematic side and front view of a beam-shaper/pre-collimator having a wavelength sensitive structure; and

FIG. 4 is a schematic side view of a blazed grating structure.

In order to address the problem of refractive index of an optical component (such as a pre-collimator, beam-shaper or sensor lens) varying with temperature it is proposed to integrate a wavelength sensitive (such as a grating structure or stepped phase structure) on the optical component, which structure compensates for the defocusing in temperature due to the change of the refractive index with temperature of the material. The wavelength sensitive structure forms part of an optical system of an optical read/write device.

For plastics materials the change of refraction index with temperature is larger than for glass materials. The invention is therefore most beneficial for plastics optical components.

FIG. 3 shows front and side views of a pre-collimator 28 (which could equally represent a servo-lens or beam-shaper) having a wavelength sensitive structure 30 on a front face thereof. A reader/writer incorporating the pre-collimator 28 shown in FIG. 3 is implemented, for example, in a structure like that shown in FIG. 2. Thus FIG. 2 would be changed only to introduce a pre-collimator or beam-shaper 28 (as in FIG. 3) for the pre-collimator 10 or beam-shaper 18 in FIG. 2.

In the case of a light path with two lasers (discrete lasers or separate laser-branches), such as that shown in FIG. 2, the pre-collimator 10 and beam-shaper 18 are behind one laser each, which means only one wavelength is of interest. It is also foreseen that three or more lasers may be used, for example to allow the use of three different formats, such as CD, DVD and Bluray Disc (BD).

One possibility to address the change of the laser wavelength with temperature is the use of a non-periodic phase structure as described in Appl. Opt. Vol. 40 no 35 6548-6560, the contents of which are incorporated herein by reference. The height h of the steps in the structure are in fixed steps with

$$h = \frac{λ}{n - 1} \qquad ( 2 )$$

Say that j is the number of steps. For that case the zone height is mⱼ.h with mⱼ an integer. If Δλ is the wavelength shift and Δn is the refracting index change (both due to temperature) the phase steps ΔΦⱼ are:

$$Δ {Φ}_{j} = - 2 π {m}_{j} \cdot ( \frac{Δ λ}{λ} - \frac{Δ n}{n - 1} ) \qquad ( 3 )$$

Another possibility is using other diffractive structures like a blazed grating or kinoform grating, which are also wavelength sensitive.

A blazed grating is a structure as shown in FIG. 4. When the angle of the gratings in the structure are such that the angle of refraction is the same as the angle of diffraction, then 100% of the laser power will go into one order (for instance the +1 order). This is the case for

$$Ψ = \frac{λ}{p \cdot ( n - 1 )} \qquad ( 4 )$$

Ψ: the blaze angle
λ: the wavelength is the laser
p: grating pitch
n: refracting index of the grating material

The kinoform grating is like the blazed grating, but it has a more rounded shape.

For a lens having a wavelength sensitive diffractive grating structure, the power of the grating is part of the total power of the lens, which is the case of this invention.

The power of the grating structure is designed in such a way that the wavelength shift of the laser causes exactly the same focal length shift of the lens as by the change of the refracting index change with temperature of the body, however with opposite sign.

The servo or sensor lens 56 for the focus adjustment is also not in the common path: only in the detector path 26 and not in the laser path 14/22. The sensor lens 56 usually comprises a spherical and an astigmatic surface. It could also be that some chromatic aberration correction is implemented in this sensor lens 56.

The lens 56 will also cause defocus with temperature, because it is not in the common path. However this effect is not so strong, and is described by (approximation with planar convex or concave lens)

$$\frac{d z}{d T} = \frac{{( 1 - \frac{{NA}_{in}}{{NA}_{out}} )}^{2} \cdot f}{( 2 \cdot {m}_{c}^{2} ) \cdot ( n - 1 ) \cdot {( \frac{{NA}_{in}}{{NA}_{out}} )}^{2}} \cdot \frac{d n}{d T} \qquad ( 5 )$$

with the parameters as described with formula (1)

When a single detector is applied the servo or sensor lens 56 in front of the detector must operate correctly at 2 wavelength ranges (although as mentioned above more than 2 wavelength ranges could be used). The temperature compensation on this lens is chosen for the most critical application, which is in general the shortest wavelength (for instance DVD λ=660 nm). Alternatively, a structure may be used to give a mixed effect on both wavelengths.

The above is also for the situation when a beam-shaper or pre-collimator is applied together with a dual wavelength laser (two laser-chips having different wavelength ranges in one package).

A similar setup can easily be devised in the case that the optical read/write device uses more than two wavelength ranges. For example, in the case of an optical reading/writing device for CD, DVD and BD applications there would be three branches as opposed to the two laser branches 14/22 in the embodiment described above.

1. An optical data reading/writing device for reading/writing to an information layer, the device comprising at least a first radiation source for generating a radiation beam and an optical system for converging the radiation beam on the information layer and for converging the radiation beam reflected by the information layer onto a detector, wherein the optical system incorporates a wavelength sensitive structure which compensates for a temperature-induced defocusing of the optical system.

2. An optical data reading/writing device as claimed in claim 1, in which the wavelength sensitive structure is a part of a refracting pre-collimator, a beam-shaper or a sensor lens of the optical system.

3. An optical data reading/writing device as claimed in claim 1, in which the wavelength sensitive structure is located out of a common path for the radiation beam.

4. An optical data reading/writing device as claimed in claim 3, in which the wavelength sensitive structure is located between the at least one radiation source and a pre-collimator/beam-shaper of the optical system.

5. An optical data reading/writing device as claimed in claim 3, in which the wavelength sensitive structure is located between a beam-splitter element and a detector element of the optical data reading/writing device.

6. An optical data reading/writing device as claimed in claim 1, in which the wavelength sensitive structure is a grating structure.

7. An optical data reading/writing device as claimed in claim 1, in which the wavelength sensitive structure is a stepped phase structure.

8. An optical data reading/writing device as claimed in claim 1, in which the wavelength sensitive structure is a non-periodic phase structure.

9. An optical data reading/writing device as claimed in claim 1, in which the wavelength sensitive structure is a diffractive structure.

10. An optical data reading/writing device as claimed in claim 1, which incorporates multiple radiation sources for reading/writing to different types or formats of information layer.

11. An optical data reading/writing device as claimed in claim 1, in which the wavelength sensitive structure faces its respective radiation source.

12. A method of compensating for temperature-induced defocusing of an optical system in an optical reading/writing device comprises including a wavelength sensitive structure in the optical system, which wavelength sensitive structure compensates for said defocusing.

13. The method as claimed in claim 12, in which the wavelength sensitive structure faces a radiation source of the reading/writing device.

14. The method of claim 12, which includes compensating for defocusing in at least two elements of the optical system.

15. The method of claim 14, in which each of said elements has an associated wavelength sensitive structure.

16. A refracting pre-collimator/beam-shaper/sensor lens for compensating for temperature defocusing incorporates a wavelength sensitive structure adapted to compensate for temperature defocusing.
